(19) United States
(12) Patent Application Publication
(10) Pub. No.: US 2010/0219167 A1
(43) Pub. Date: Sep. 2, 2010

(54) METHOD AND DEVICE FOR THE MARGINAL CONNECTION OF SHEET METALS USING A CONNECTING DEVICE FOR LASER OPTICS

(76) Inventors: Winfried Schwarz, Uberherrn (DE); Thilo Trabner, Uberherrn (DE)

Correspondence Address: MCGLEW & TUTTLE, PC, P.O. BOX 9227, SCARBOROUGH STATION, SCARBOROUGH, NY, 10510-9227, US

(21) Appl. No.: 12/682,956

(22) PCT Filed: Nov. 26, 2008
(86) PCT No.: PCT/EP2008/010005

§ 371 Date: Apr. 14, 2010

(30) Foreign Application Priority Data
Dec. 14, 2007 (DE) 10 2007 060 484.1

(51) Int. Cl. B23K 26/22

(52) U.S. Cl. 219/121.64; 219/121.63

(57) ABSTRACT

A method and to a device are provided for the marginal connection of sheet metals (8,9), particularly of car body sheets in automobile construction. In the device (1) the edge of a first sheet metal (8) is crimped over the edge of the second sheet (9) to form a fold (10). The edges are pressed together and connected to each other by thermal joining. In the region of the fold (10), at least one connecting device (7) is attached for the laser optics of a laser welding unit.

Subsequent to the folding operation the laser optics is introduced in the region of the connecting device (7). At least one weld point and/or a weld seam is produced in the fold region. The laser optics is removed from the connecting device (7) and optionally connected to further connecting devices (7), and after all necessary weld points or weld seams have been produced, the finished component is removed from the device (1).

### CROSS REFERENCE TO RELATED APPLICATIONS

This application is a United States National Phase application of International Application PCT/EP2008/010005 and claims the benefit of priority under 35 U.S.C. §119 of German Patent Application 10 2007 060 484.1 filed Dec. 14, 2007, the entire contents of which are incorporated herein by reference.

### FIELD OF THE INVENTION

The invention relates to a method and to a device for the marginal connection of sheet metals, particularly of car body sheets in automobile construction, wherein in a device the edge of a first sheet metal is crimped over the edge of the second sheet to form a fold, and wherein the edges are pressed together and connected to each other by thermal joining

### BACKGROUND OF THE INVENTION

DE 199 27 208 B4 discloses a method for marginal connection of sheet metal panels, more particularly of car body panels in automobile construction, wherein the edge of an outer panel is folded over the edge of an inner panel and wherein the edges are compressed together. Prior to folding, the edge of at least one of the sheet metal panels is provided with protrusions that are stamped into it and the protrusions join onto the other panel by projection welding during compression. Used for this method is an electrode that can be lowered onto the protrusions, there being provided apart of the electrode a contact electrode that can be lowered onto the sheet metal panels.

By U.S. Pat. No. 5,897,796 a method for marginal connection of sheet metal plates has become known, and according to this method, too, the edge of an outer plate is folded over the edge of an inner plate. In the area of the fold, at least one seam running continuously over a predetermined length is generated by laser welding in the area of the fold, thus establishing a connection between the sheet metal plates. Preferably applied is a Nd:YAG laser comprised of a computer-controlled laser beam generator being effectively connected via a multitude of fibres to several laser guns. Owing to this spatial configuration, substantial space is needed within the folding device which in any way has small dimensions.

### SUMMARY OF THE INVENTION

Now, therefore, it is the underlying task of the present invention to optimize the described method and at the same time to provide a device which despite its lesser demand for space has an improved functioning as compared with prior art in technology.

In compliance with the proposed method, this tasked is solved by mounting at least one connecting device for the laser optics of a laser welding equipment in the area of the fold, and that subsequent to the folding operation the laser optics is introduced in the region of the connecting device, and that at least one weld spot and/or a weld seam is produced in the fold region to connect the sheet metal plates, and that the laser optics is removed from the connecting device and optionally connected to further connecting devices and after all necessary weld spots or weld seams have been produced, the finished component is removed from the device.

With a device for marginal connection of sheet metal plates, more particularly for car body panels in automobile construction, which at least comprises a folding bed to take-up at least two sheet metal plates, folding jaws being effectively connected to associated folding jaw carriers as well as comprised of at least one thermal joining tool, this task is solved in that the relevant thermal joining tool is configured as a laser spot welding equipment that co-acts with a connecting device provided in the area of the associated folding jaw, wherein the laser optics of the laser spot welding equipment can be introduced from an off-duty position at least partially into the area of the connecting device and wherein after having introduced the laser optics into the connecting device and having actuated the laser optics the relevant weld spot in the folding area of the sheet metal plates can be generated.

As compared with DE 199 27 208 B4, the advantage achieved is that it is no longer required to generate protrusions on the sheet metal and that a contact electrode can be dispensed with.

The advantage achieved as compared with U.S. Pat. No. 5,897,796 is substantiated in that by the separation of the stationary connecting device and the mobile laser optics much less space is required in the area of the folding device.

Owing to the direct connection of the laser optics to the connecting device or to the opening in the folding jaw, an at least optically leak-proof, quick-to-engage connection is generated so that the laser beam cannot leak to the outside and that a costly shielding and an additional guard cabin, if any, can be dispensed with.

The relevant laser optics can be handled on demand by at least one robot. In contrast with prior art in technology, no long continuous weld seams are generated but only weld points or only short weld seams which are preferably achieved by a minor swivelling movement of the laser optics.

Owing to the special configuration of the holding-down device, this device can take-up the guard sleeve in itself so that the required construction space is further minimized.

It is of advantage to provide the inner planar areas of the connecting device with a coating which no splash material adheres to and/or from which any adhesive material can be easily removed. By taking this measure, it is intended to avoid rapid clogging of the connecting device. Suitable layers are ceramic layers in particular, with it also being possible to apply metallic layers such as chromium layers, if required. Alternatively it is also feasible to manufacture the connecting device configured as a pipe, for example, completely from ceramic material.

The inventive object is illustrated by way of an exemplary embodiment shown in the drawing and described below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view showing the inventive device for marginal connection of sheet metal plates in various views and/or sections;

FIG. 2 is a sectional view showing the inventive device for marginal connection of sheet metal plates in various views and/or sections;

FIG. 3 is a perspective view showing a holding-down device in the pre-folding area; and

FIG. 4 is a perspective view showing the holding-down device according to FIG. 3 including an indicatively illustrated thermal joining device in the finish-folding area.

### DESCRIPTION OF THE PREFERRED EMBODIMENTS

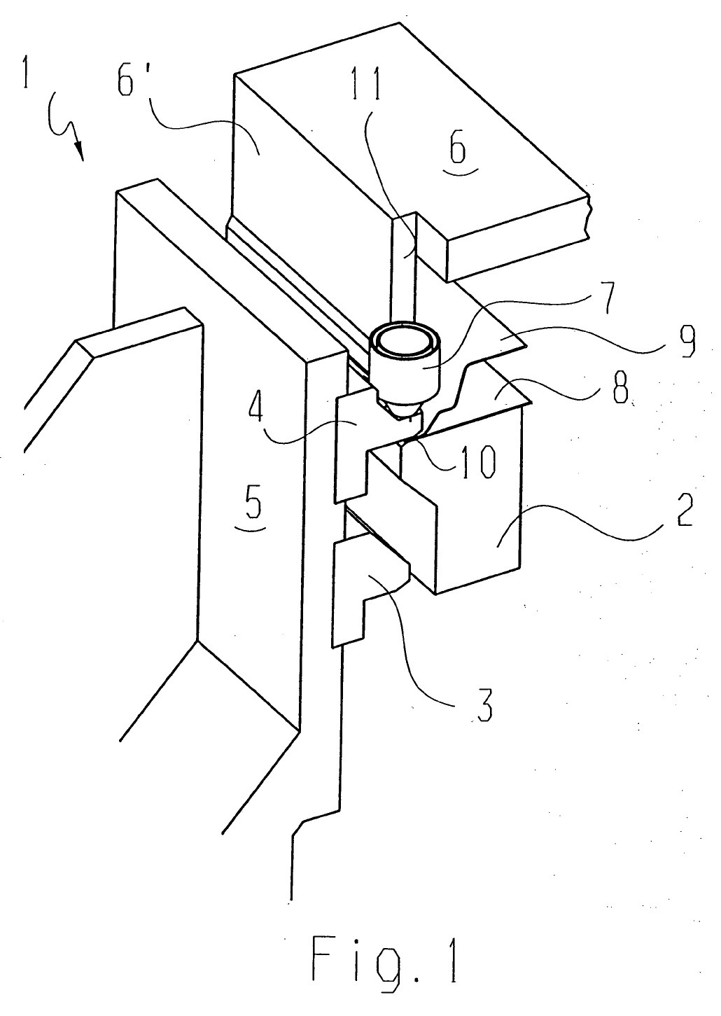

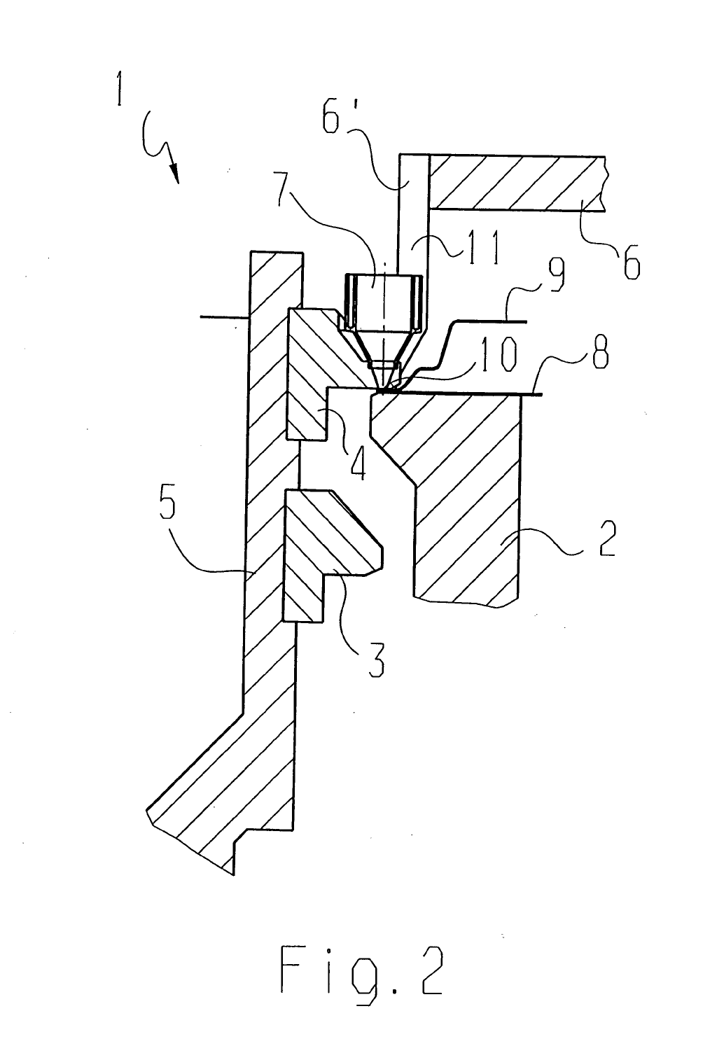

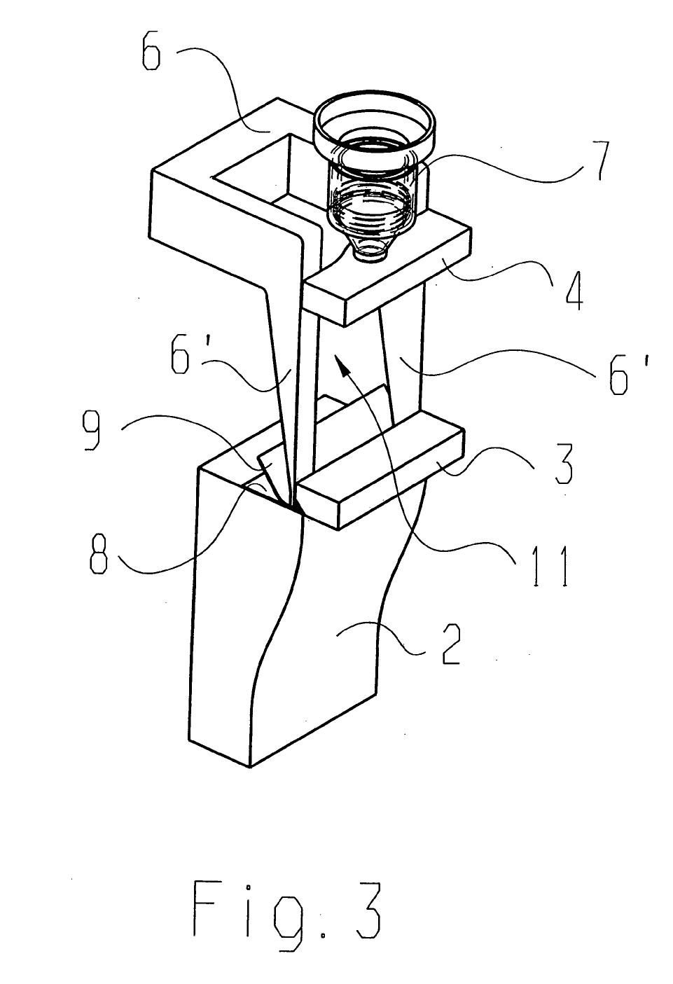

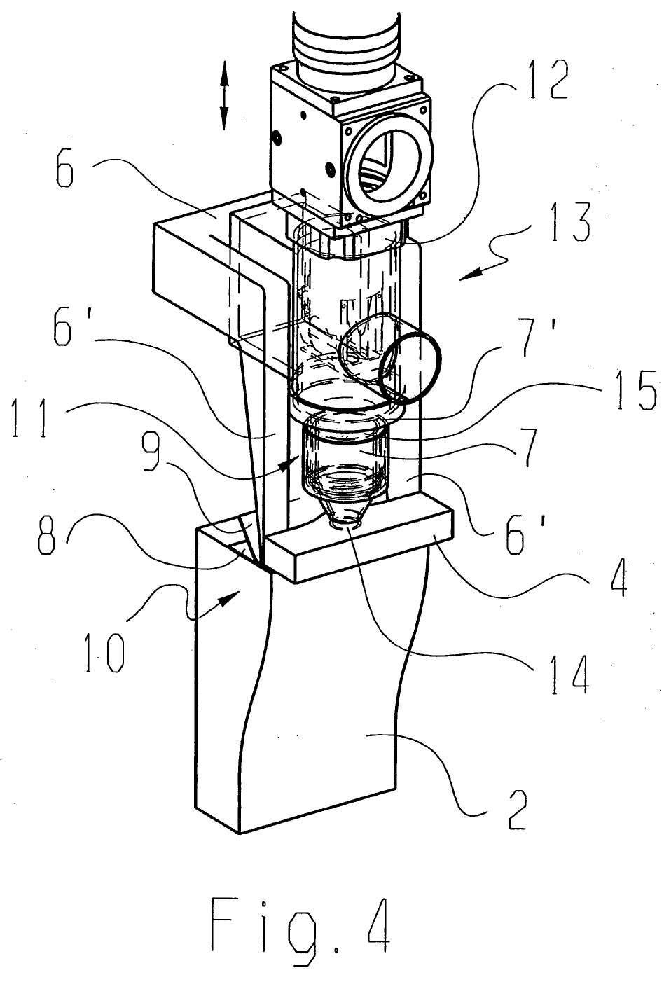

Referring to the drawings in particular, FIGS. 1 and 2 show the inventive device 1 for marginal connection of components in various views and/or sections. The following components can be seen: A folding bed 2, lower folding jaws 3, (pre-folding jaws), upper folding jaws 4 (finish-folding jaws), folding jaw carriers 5, holding-down devices 6, a connecting device 7 in form of a pipe, a first sheet metal plate 8 as well as a second sheet metal plate 9 and an indicatively illustrated fold 10 in the area between the upper folding jaw 4 and folding bed 2. The pipe 7 is provided stationary in the area of the upper folding jaw 4, i.e. it is firmly connected to it. The holding-down device is configured in angular shape, with the vertically extending leg 6′ having a recess 11 that grips over pipe 7. In FIGS. 3 and 4, the holding-down device 6 is shown in spatial representation.

FIG. 3 shows the status in which the sheet metal plates 8,9 are pre-folded. One can see the folding bed 2, the lower folding jaw 3, the upper folding jaw 4, the tubular connecting device 7, and the holding-down device 6. By forming the recess 11, two vertically extending fork-like shaped legs 6′ are produced, the free ends of which rest on in the pre-folding area of sheet metal plates 8, 9.

FIG. 4 shows the folding bed 2, the upper folding jaw 4, the tubular connecting device 7, the holding-down device 6 as well as the sheet metal plates 8,9. In supplementing this illustration, one can see the thermal joining tool 12 in form of a laser spot welding equipment. In this example, the laser spot welding equipment 12 is to be movable in vertical direction (direction of the arrow), for example by way of a robot, and it comprises an only indicatively illustrated laser optics 13 that can be introduced into the upper marginal area of the pipe 7. The upper marginal area of the pipe 7 co-acts in an advantageous manner with a flexibly configured sleeve 7′, thus making it easier to introduce the laser optics 13 into the pipe 7. The sleeve 7′ can be provided either at the laser optics 13 or at the pipe 7. Accordingly, pipe 7 should be regarded as a guard tube because on actuating the laser optics 13 a high energy beam extending in the direction of fold 10 is generated, by way of which material is instantly displaced from the laser area. To prevent this material from getting stuck to the inner circumference of the pipe 7 and to prevent it from getting clogged within a very short time, pipe 7—according to another idea of the present invention—is coated with a ceramic layer at least in the area of its inner peripheral area.

However, other materials, e.g. chromium layers or the like, which can prevent metal from getting stuck to the inner peripheral area are also conceivable. In FIG: 4 it can be clearly seen that the pipe 7 is positioned between the vertically extending legs 6′ of the holding-down device 6 in the void of the recess 11 given between the legs 6′. In the upper folding jaws 4, a recess 14 is provided within which the free end of the pipe 7 is positioned. One can also see the connecting area 15 of sleeve 7′ which is immersed into the pipe 7.

It is also conceivable (not shown here) to configure the recess 14 itself as a connecting device for the laser optics 13, respectively the sleeve 7′.

To produce several spaced welding points, one can either use an individual laser optics 13 which is swung into the area of spaced connecting devices 7,14 in robot-controlled manner or one can work with several laser spot welding devices 12. Instead of one laser spot welding device 12, it is in principle also possible to apply an electronic beam or laser soldering method for connecting the sheet metals 8 and 9.

While specific embodiments of the invention have been described in detail to illustrate the application of the principles of the invention, it will be understood that the invention may be embodied otherwise without departing from such principles.

1. A method for the marginal connection of sheet metals of car body sheets in automobile construction, the method comprising the steps of:
providing a device;
providing a laser welding unit with laser optics
crimping the edge of a first sheet metal over the edge of the second sheet in the device to form a fold;
pressing the edges together and connecting the edges to each other by thermal joining;
attaching, in the region of the fold, at least one connecting device for the laser optics of the laser welding unit;
subsequent to forming the fold, introducing the laser optics in the region of the relevant connecting device;
producing at least one weld point and/or a weld seam in the fold region;
removing the laser optics from the connecting device and and
after all necessary weld spots or weld seams have been produced, removing the finished component from the device.

2. A method according to claim 1, wherein the laser optics is guided by a robot into the region of the connecting device.

3. A method according to claim 1, wherein the spot welding or weld seam in the folding region is performed with closed folding jaws and provides a pre-tensioned fold.

4. A method according to claim 1, wherein several weld spots or weld seams are generated consecutively with the same laser optics or several laser welding units are used for generating several spaced weld spots or weld seams.

5. A device for marginal connection of sheet metal sheets for car body panels in automobile construction, the device comprising:
a folding bed to take-up at least two sheet metal sheets (8,9), of sheet metal sheets;
folding jaws effectively connected to associated folding jaw carriers;
a thermal joining tool configured as a laser spot welding equipment with laser optics;
a connecting device provided in the area of the associated folding jaw, the connecting device defining a receiving region wherein the laser optics of the laser spot welding equipment can be introduced from an off-duty position at least partially into the receiving region of the connecting device and wherein after having introduced the laser optics into the connecting device and having actuated the laser optics the relevant weld spot or a weld seam is produced in the folding region of the of sheet metal sheets.

6. A device according to claim 5, wherein the connecting device is formed by a recess provided in the relevant folding jaw and extending in the direction of the folding region of sheet metal sheets or by a pipe firmly arranged in the relevant folding jaw in a take-up bore.

7. A device according to claim 6, wherein the contour of the connecting device, starting-out from the laser optics, is tapered in the direction of the folded region.

8. A device according to claim 5, wherein at least the part of the connecting device accommodating the laser optics is made of a material that rejects any splash material.

9. A device according to claim 6, wherein the pipe as connecting device has an inner peripheral area provided with a chromium or ceramic layer.

10. A device according to claim 6, wherein the pipe co-acts with a flexible sleeve arranged in the area of the laser optics or the connecting device.

11. A device according to claim 10, wherein the flexible sleeve is comprised of a connecting area facing the connecting device.

12. A device according to claim 5, wherein a holding-down device roughly shaped in its cross-section like an angle is positioned at least in the region of the associated folding jaw at the folding bed side, said holding-down device being comprised of a recess at least in the region of its leg facing the folding jaw, said recess framing the pipe.

13. A device according to claim 5, wherein the laser optics is configured as a diode laser.

14. A device for marginal connection of sheet metal sheets, the device comprising:
a folding bed to take-up at least two sheet metal sheets;
folding jaws effectively connected to associated carrier structure;
a thermal joining tool configured as a laser spot welding unit with laser optics;
a connecting device provided at or adjacent to one of said folding jaws, the connecting device defining a receiving region wherein the laser optics of the laser spot welding equipment can be introduced from an off-duty position at least partially into the receiving region of the connecting device and wherein after having introduced the laser optics into the connecting device and having actuated the laser optics the relevant weld spot or a weld seam is produced in the folding region of the of sheet metal sheets.

15. A device according to claim 14, wherein the connecting device comprises at least one of:
a recess formed in or connected to one of said folding jaws and extending in the direction of the folding region of sheet metal sheets; and
a pipe firmly arranged in or on one of said folding jaws in a take-up bore.

16. A device according to claim 15, wherein the connecting device has a contour starting-out from the laser optics and tapering in a direction of a folded region defined by said folding jaws.

17. A device according to claim 15, wherein the pipe as connecting device has an inner peripheral area provided with a chromium or ceramic layer.

18. A device according to claim 15, wherein the pipe co-acts with a flexible sleeve arranged in an area of the laser optics or the connecting device, wherein the flexible sleeve is comprised of a connecting area facing the connecting device.

19. A device according to claim 15, further comprising a holding-down device roughly shaped in its cross-section like an angle is positioned at least in the region of the associated folding jaw at the folding bed side, said holding-down device being comprised of a recess at least in the region of its leg facing the folding jaw, said recess framing the pipe.
